(19) United States
(12) Patent Application Publication
(10) Pub. No.: US 2015/0363033 A1
(43) Pub. Date: Dec. 17, 2015

(54) MOBILE TERMINAL DEVICE

(71) Applicant: KYOCERA Corporation, Kyoto-shi (JP)

(72) Inventor: Ryosuke OKABE, Osaka (JP)

(73) Assignee: KYOCERA Corporation

(21) Appl. No.: 14/835,536

(22) Filed: Aug. 25, 2015

Related U.S. Application Data
(63) Continuation of application No. PCT/JP2014/054656, filed on Feb. 26, 2014.

(30) Foreign Application Priority Data
Feb. 26, 2013 (JP) 2013-035551

(51) Int. Cl. G06F 3/041; G06F 1/16; H04W 52/02; G06F 1/32

(52) U.S. Cl. CPC G06F 3/0412; G06F 1/3206; G06F 1/1647; H04W 52/027; H04W 52/0254

(57) ABSTRACT

A mobile phone includes: a first display provided in a front surface of a cabinet, the first display requiring electric power to keep displaying an image; a touch panel configured to detect an operation performed by a user onto the first display; a second display provided in a rear surface of the cabinet, the second display requiring no electric power to keep displaying an image; and a control module configured to control the first display and the second display. The control module is configured to: display an image on the first display in accordance with the user's operation and turn off the first display when the user's operation has not been detected by the touch panel for a predetermined time; and display predetermined information on the second display, the predetermined information being able to be seen by the user when the first display is off.

### CROSS-REFERENCE TO RELATED APPLICATION

The present application is a bypass continuation of international PCT Application No. PCT/JP2014/054656 filed on Feb. 26, 2014, entitled “Portable Terminal Apparatus”, which claims the benefit of Japanese Application No. 2013-035551 filed on Feb. 26, 2013, entitled “Mobile Terminal Device”. The disclosure of the above applications are each incorporated herein by reference.

### FIELD

The present disclosure relates to mobile terminal devices, such as a mobile phone, a PDA (Personal Digital Assistant), a tablet PC, and an electronic book terminal.

### BACKGROUND

Conventionally, there has been known a mobile phone including a display arranged in the front surface of its housing. In such a mobile phone, for example, a display having a substantially rectangular shape and slightly smaller than a housing having a substantially rectangular contour is disposed in the front surface of the housing. Furthermore, a touch panel is provided to overlap with the display, and various types of application programs (hereinafter, simply referred to as “applications”) are executed based on a user's touch operation onto the display.

### SUMMARY

A mobile terminal device according to one embodiment of the present disclosure includes: a housing comprising a first surface and a second surface different from the first surface; a first display module provided in a first surface, the first display module requiring electric power to keep displaying an image; an operation detection module configured to detect an operation performed by a user onto the first display module; a second display module provided in a second surface different from the first surface, the second display module requiring less electric power than the first display module to keep displaying an image; and a control module configured to control the first display module and the second display module. Here, the control module is configured to: display an image on the first display module in accordance with the operation and turn off the first display module when the operation has not been detected by the operation detection module for a predetermined time; and display predetermined information on the second display module, the predetermined information being able to be seen by the user when the first display module is off.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows a configuration of a mobile phone of an embodiment.

FIG. 2 is a block diagram showing an entire configuration of the mobile phone.

FIG. 3 shows a first display having a home screen displayed thereon and a second display having an information display screen displayed thereon.

FIG. 4 is a flowchart showing a process associated with settings of a lock function.

FIG. 5 is a flowchart showing a process associated with an information setting application.

FIG. 6 shows an example of an information selection screen.

FIG. 7 shows an example of an information layout screen.

FIG. 8 shows display states of the first display and second display when a delete button is operated.

FIG. 9 shows an example of an information obtainment target list.

FIG. 10 is a flowchart showing a setting process for setting information to be displayed on the second display.

FIG. 11 shows an example in which information to be displayed on the second display is set on a memo writing screen in a memo pad application.

FIG. 12 shows an example in which information to be displayed on the second display is set on a weather report screen in a weather report application.

FIG. 13 illustrates a display process with respect to the second display.

FIG. 14 illustrates a display process with respect to the second display.

FIG. 15 shows an information display screen displayed on the second display.

FIG. 16 shows a configuration of a mobile phone of an embodiment.

### DETAILED DESCRIPTION

A display used for a mobile phone is normally of a type that requires electric power to renew an image displayed on the display and that requires electric power to keep displaying the renewed image, such as a liquid crystal display or an organic EL display.

In the mobile phone, when a user does not use the mobile phone, the display may be turned off in order to suppress power consumption. Accordingly, whenever the user checks a small piece of information such as time, calendar, or weather report, the user may need to operate the mobile phone and turn on the display.

Therefore, a demand arises in a mobile terminal device allowing a user to readily obtain information while suppressing power consumption.

Hereinafter, an embodiment of the present disclosure will be described with reference to figures.

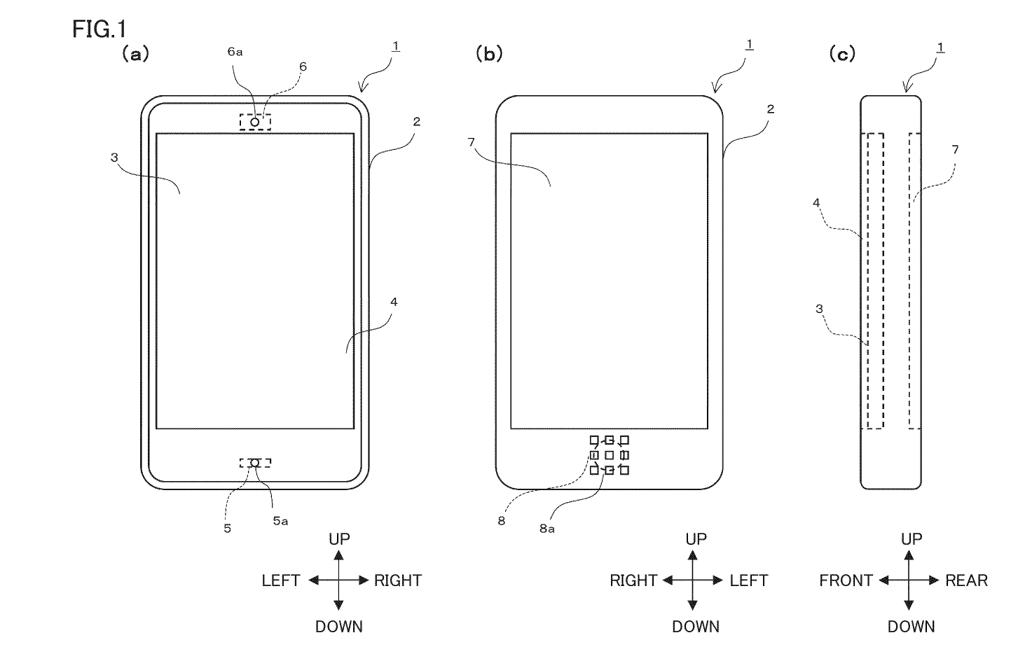

FIG. 1 (a), FIG. 1 (b), and FIG. 1 (c) are respectively a front view, a rear view, and a right side view of a mobile phone 1. In the description below, for the ease of explanation, as shown in FIG. 1 (a) to FIG. 1 (c), the long side direction of a cabinet 2 that is a housing of mobile phone 1 is defined as a vertical direction and the short side direction of cabinet 2 is defined as a horizontal direction.

As shown in FIG. 1, mobile phone 1 includes cabinet 2, a first display 3, a touch panel 4, a microphone 5, a talk speaker 6, a second display 7, and an external speaker 8.

Cabinet 2 may have a substantially rectangular contour when viewed from the front. First display 3 is provided in the front surface of cabinet 2. First display 3 is of a type that requires electric power to renew an image displayed on the display and that requires electric power to keep displaying the renewed image. First display 3 is a liquid crystal display, for example. First display 3 may be a display other than the liquid crystal display, such as an organic EL display. First display 3 may be a color display.

In the front surface of cabinet 2, touch panel 4 can be provided to cover first display 3. Touch panel 4 is in the form of a transparent sheet. As touch panel 4, various types of touch panels may be used, such as a capacitance type touch panel, an ultrasonic type touch panel, a pressure-sensitive type touch panel, a resistance film type touch panel, and an optical detection type touch panel.

Microphone 5 may be disposed in cabinet 2 at the lower end portion. Microphone 5 can receive a sound having passed through a microphone hole 5a in the front surface of cabinet 2. Microphone 5 can generate an electric signal in accordance with the sound thus input. Moreover, talk speaker 6 can be disposed in cabinet 2 at its upper end portion. Talk speaker 6 can output a sound. The sound thus output passes through an output hole 6a in the front surface of cabinet 2 and is emitted out of cabinet 2. During talking, speech received from a counterpart device (such as a mobile phone) in communication is output from talk speaker 6 and speech made by the user is input to microphone 5. It should be noted that the sound includes various types of sounds, such as speech and informing sound.

In the rear surface of cabinet 2, second display 7 can be provided. Second display 7 may have substantially the same size as first display 3. Second display 7 is of a type that requires electric power to renew an image displayed on the display but does not require electric power to keep displaying the renewed image. Second display 7 is an electronic paper display, for example. Second display 7 may be a display other than the electronic paper display, such as a memory liquid crystal display. Second display 7 may be a monochrome display or a color display.

It should be noted that first display 3 has higher renewing rate and higher resolution than those of second display 7.

External speaker 8 may be disposed in cabinet 2. In the rear surface of cabinet 2, an output hole 8a is at a region facing external speaker 8. A sound output from external speaker 8 passes through output hole 8a and is emitted out of cabinet 2.

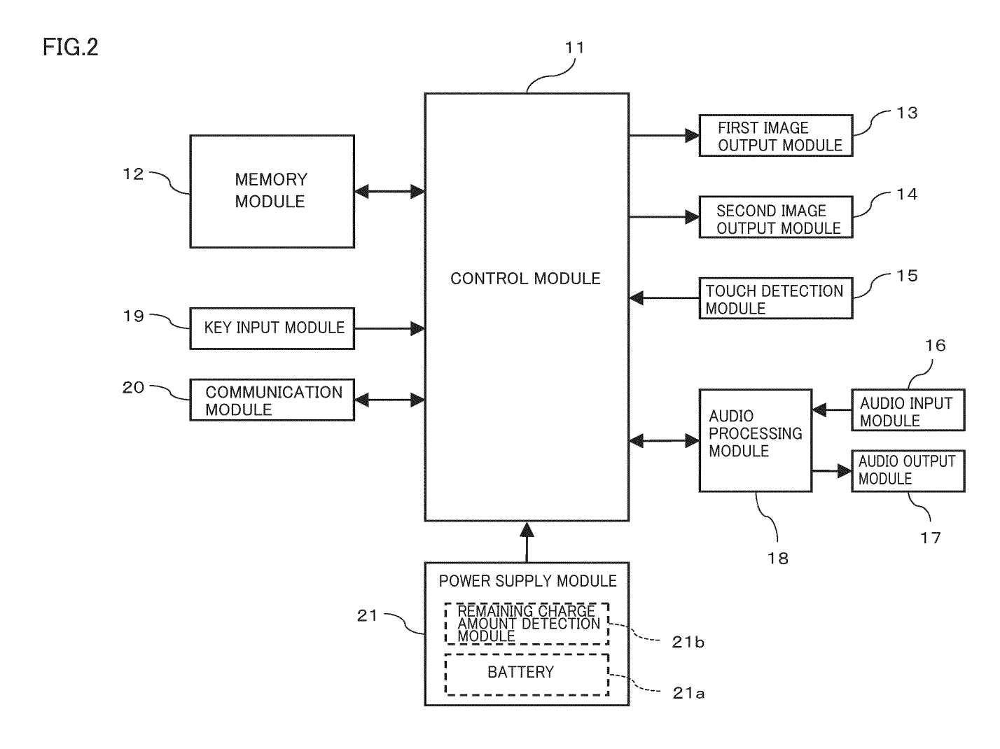

FIG. 2 is a block diagram showing the entire configuration of mobile phone 1.

As shown in FIG. 2, mobile phone 1 includes a control module 11, a memory module 12, a first image output module 13, a second image output module 14, a touch detection module 15, an audio input module 16, an audio output module 17, an audio processing module 18, a key input module 19, a communication module 20, and a power supply module 21.

Memory module 12 may include a ROM, a RAM, and an external memory. Various types of programs may be stored in memory module 12. The programs stored in memory module 12 include: control programs for controlling modules of mobile phone 1; and various types of applications (such as a home application, a telephone application, an e-mail application, a web browser, a map application, a game application, and a schedule management application). The programs may be stored in memory module 12 by the manufacturer during production of mobile phone 1, and may be stored in memory module 12 by the user via a communication network or a storage medium such as a memory card or a CD-ROM.

Memory module 12 may include a working area in which data temporarily used or generated is stored when a program is executed.

Control module 11 may include a CPU. In accordance with a program stored in memory module 12, control module 11 controls each of the modules included in mobile phone 1 (memory module 12, first image output module 13, second image output module 14, touch detection module 15, audio input module 16, audio output module 17, audio processing module 18, key input module 19, communication module 20, and the like).

First image output module 13 includes first display 3 shown in FIG. 1 (a). First image output module 13 can display an image (screen) on first display 3 based on control signal and image signal from control module 11.

Second image output module 14 includes second display 7 shown in FIG. 1 (b). Second image output module 14 can display an image (screen) on second display 7 based on control signal and image signal from control module 11.

Touch detection module 15 includes touch panel 4 shown in FIG. 1 (a). Touch detection module 15 can detect the user performing a touch operation onto first display 3, by means of touch panel 4. Specifically, when the user touches the inside of a region of first display 3, touch detection module 15 can detect a position (hereinafter, referred to as “touch position”) touched by the user, using touch panel 4. Touch detection module 15 can output a position signal, which is generated based on the detected touch position, to control module 11.

Since touch panel 4 is provided on first display 3, the user can perform various types of touch operations by touching touch panel 4 with a finger. Examples of the touch operations include a tap operation, a flick operation, a slide operation, a drag operation, and the like. The tap operation is an operation such that the user brings a finger into contact with touch panel 4 and then lifting the finger away from touch panel 4 in a short time. The flick operation is an operation such that the user brings a finger into contact with touch panel 4 and then flicks touch panel 4 with the finger in an intended direction. The slide operation is an operation such that the user moves a finger in an intended direction with the finger being in contact with touch panel 4. The drag operation is an operation such that the user performs a slide operation onto an object to be moved such as an icon and then lifts the finger away from touch panel 4.

For example, control module 11 can determine that a touch operation is the tap operation when touch detection module 15 detects a touch position and then the touch position has no longer been detected within a predetermined first time from the detection of the touch position. Control module 11 can determine that a touch operation is the flick operation when a touch position is moved by a predetermined first distance or longer within a predetermined second time from the detection of the touch position and then the touch position has no longer been detected. Control module 11 can determine that a touch operation is the slide operation when a touch position is detected and then is moved by a predetermined second distance or longer.

Audio input module 16 includes microphone 5. Audio input module 16 can output an electric signal from microphone 5 to audio processing module 18.

Audio output module 17 includes talk speaker 6 and external speaker 8. Audio output module 17 can receive an electric signal from audio processing module 18. Audio output module 17 can cause talk speaker 6 or external speaker 8 to output a sound.

Audio processing module 18 can perform A/D conversion or the like onto an electric signal received from audio input module 16, and can output the converted digital audio signal to control module 11. Audio processing module 18 can perform a decode process, D/A conversion and the like onto a digital audio signal received from control module 11, and then can output the converted electric signal to audio output module 17.

Key input module 19 may include at least one or more hard keys (not shown). For example, key input module 19 includes a power supply key for supplying electric power to mobile phone 1, and the like. When at least one of the various types of hard keys provided in mobile phone 1 is pressed down, key input module 19 can output a signal corresponding to the pressed hard key to control module 11.

In order to make a phone call and communication, communication module 20 includes: a circuit for converting a signal; an antenna that can transmit and receive an electric wave; and the like. Communication module 20 can convert a signal received from control module 11 for the phone call or communication into a radio signal, and transmit the converted radio signal to a communication destination such as a base station or a different communication device via the antenna. Furthermore, communication module 20 can convert a radio signal received via the antenna into a signal in a format that can be used by control module 11, and can output the converted signal to control module 11.

Power supply module 21 includes a battery 21a and a remaining charge amount detection module 21b. Power supply module 21 can supply electric power of battery 21a to control module 11 and each of the modules other than control module 11. Moreover, power supply module 21 can supply electric power from an external power supply to battery 21a in order to charge battery 21a. Furthermore, power supply module 21 can output a detection signal, which is based on an amount of charges remaining in battery 21a as detected by remaining charge amount detection module 21b, to control module 11.

Control module 11 can execute various types of applications as described above. When an application is launched, control module 11 can control first image output module 13 to display an execution screen of the application on first display 3. The execution screen may include an object to be subjected to a touch operation by the user.

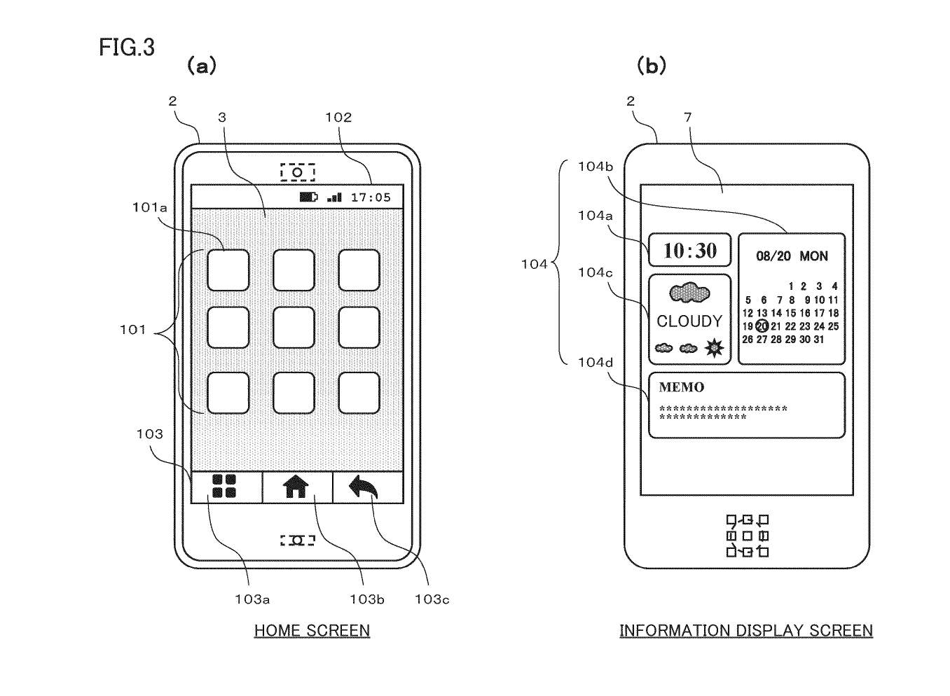

FIG. 3 (a) shows an example in which the home application is executed and a home screen is displayed on first display 3. As shown in FIG. 3 (a), in the home screen, a plurality of launching icons 101 respectively corresponding to the applications are arranged to launch the various types of applications. When the user performs a tap operation onto a launching icon 101, control module 11 can launch the application corresponding to the operated launching icon 101, thereby displaying an execution screen of the launched application on first display 3.

For example, in the case of the telephone application, a dial screen for making a phone call is displayed on first display 3. In the case of a gallery application, a browsing screen for browsing a photograph is displayed on first display 3. In the case of a motion video player application, a playback screen for playing back a motion video is displayed on first display 3.

Meanwhile, a notification bar 102 is provided at the upper portion of the home screen. Notification bar 102 includes: time at present; a remaining charge meter indicating an amount of charges remaining in the battery; an intensity meter indicating an intensity of an electric wave; and the like. Furthermore, an operation key group 103 is provided at the lower portion of the home screen. Operation key group 103 includes a setting key 103a, a home key 103b, and a back key 103c. Setting key 103a is a key mainly for displaying, on first display 3, a setting screen for various settings. Home key 103b is a key mainly for transitioning the indication on first display 3 to the home screen from another screen. Back key 103c is a key mainly for undoing an executed process to a process performed one step before the executed process.

Control module 11 can control second image output module 14 to display an information display screen on second display 7. The information display screen includes various types of information to be provided to the user, i.e., includes information images 104 indicating these types of information. Examples of the information displayed on second display 7 include time information, weather report information, calendar information, memo information, and the like. FIG. 3 (b) shows second display 7 on which the information display screen is displayed. As information images 104, the information display screen includes: a time image 104a indicating the time information; a calendar image 104b indicating the calendar information; a weather image 104c indicating the weather report information; and a memo image 104d indicating the memo information.

Information images 104 are mainly constituted of letters/characters (inclusive of numbers and signs), simple illustrations, and the like. Information images 104 do not include photographs and motion videos, which require relatively high renewing rate and resolution to attain satisfactory display.

For example, time image 104a is an image indicating time at present by letters/characters in hours and minutes. Calendar image 104b is an image indicating a calendar of the present month by letters/characters with a mark being provided at the today's date. Weather image 104c is an image represented by an illustration and letters/characters indicating today's weather forecast and by illustrations indicating weathers of past few days. Memo image 104d is an image constituted of a memo writing created by the user.

At a timing corresponding to each information, control module 11 can update information image 104 corresponding to the information. For example, control module 11 can update time image 104a at a timing at which one minute has passed. Moreover, control module 11 can update calendar image 104b at a timing at which the date is changed. Control module 11 can update weather image 104c at a timing at which information of a new weather report is obtained from an external weather report site by the weather report application. Control module 11 can update memo image 104d at a timing at which a new memo writing to be displayed on second display 7 is created by the user using a memo pad application or the like.

When mobile phone 1 comes into an unused state, control module 11 can set a lock function in order to prevent a wrong operation and suppress power consumption.

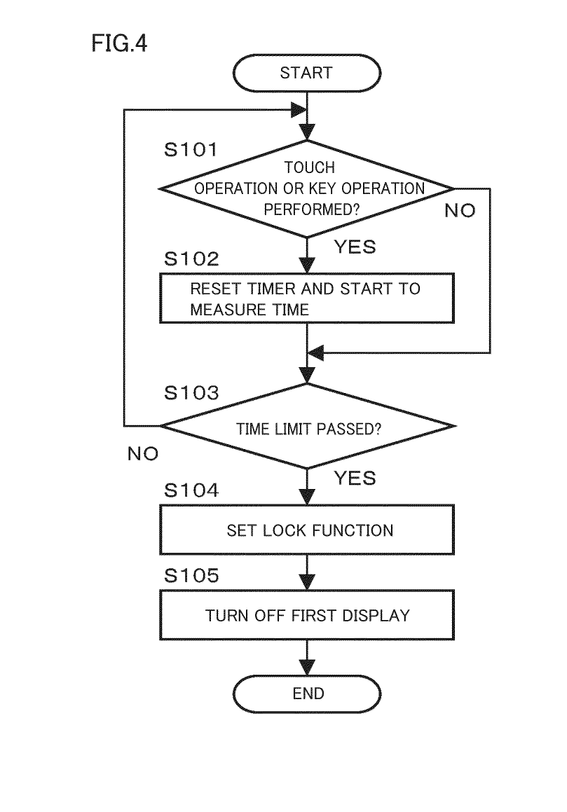

FIG. 4 is a flowchart showing a process associated with the setting of the lock function.

When the user performs a touch operation onto first display 3 or a key operation onto a hard key (S101: YES), control module 11 starts to measure time using an internal timer (S102). Control module 11 determines whether or not the measured time has passed a time limit (S103). When a next touch operation or key operation is performed before the passage of the time limit, control module 11 resets the timer and starts to measure time again (S103: NO→S101: YES→S102). On the other hand, when the measured time has passed the time limit without next touch operation or key operation (S103: YES), control module 11 can deem that mobile phone 1 comes into the unused state and can set the lock function (S104). Control module 11 can turn off first display 3 by stopping supply of electric power to first display 3 (S105). Accordingly, the execution screen displayed on first display 3 is disappeared. On the other hand, control module 11 does not perform control for second display 7 in accordance with the passage of the time limit even when the time limit has passed. Accordingly, the information display screen is maintained to be displayed on second display 7. Since second display 7 does not require electric power to keep displaying an image, electric power consumed with regard to the indication on second display 7 is only electric power required upon updating of information images 104, thus attaining a slight amount of electric power consumed.

When the lock function is set, reception of an operation by the user is restricted. Namely, control module 11 can invalidate operations other than an operation for canceling the setting of the lock function.

When the user performs a predetermined canceling operation, control module 11 can cancel the setting of the lock function. Control module 11 can turn on first display 3, and can display, on first display 3, the execution screen or home screen having been displayed before the lock function has been set. Furthermore, control module 11 can cancel the restriction of operations.

Mobile phone 1 includes an application (hereinafter, referred to as “information setting application”) for setting information to be displayed on second display 7. As shown in FIG. 3 (a), a launching icon 101a corresponding to the information setting application is included in launching icons 101 of the home screen. When the user performs a tap operation onto launching icon 101a, the information setting application is launched.

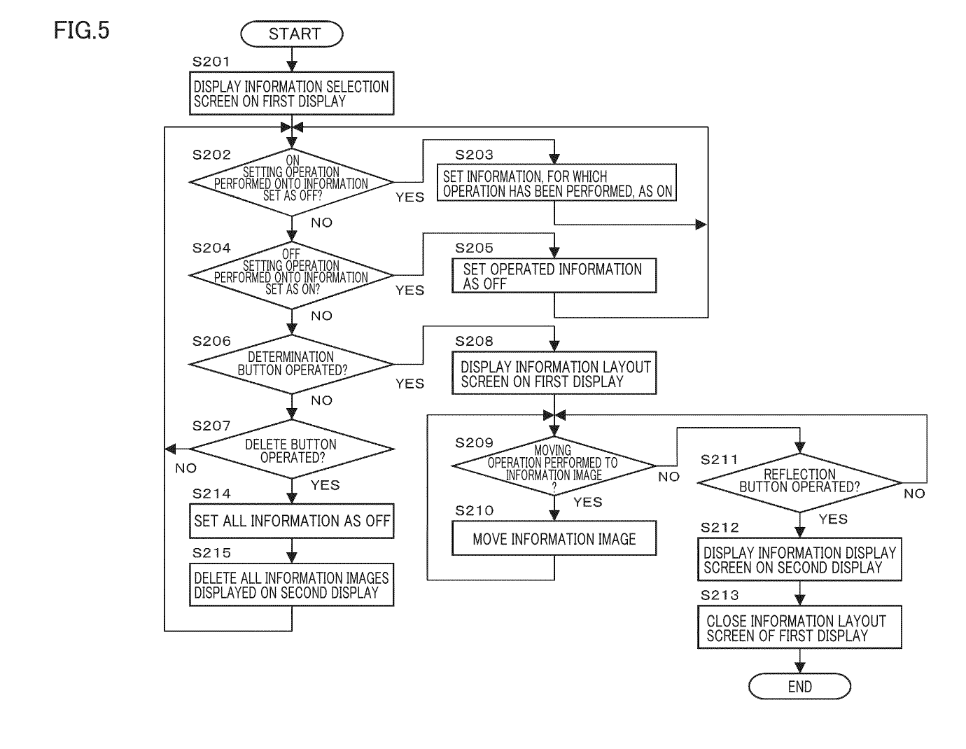

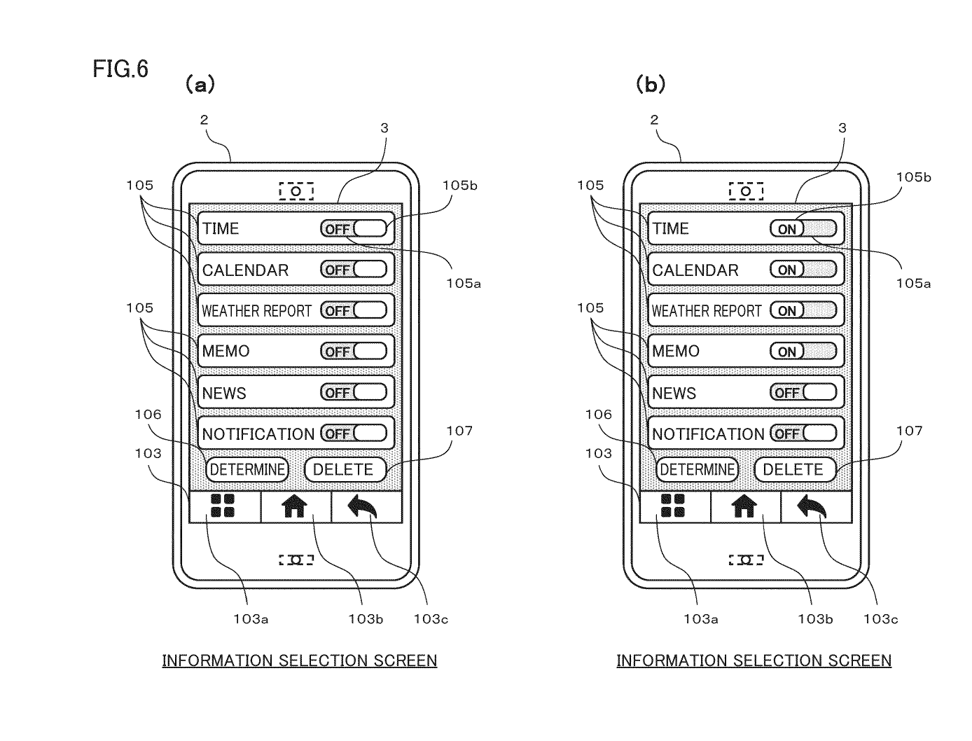

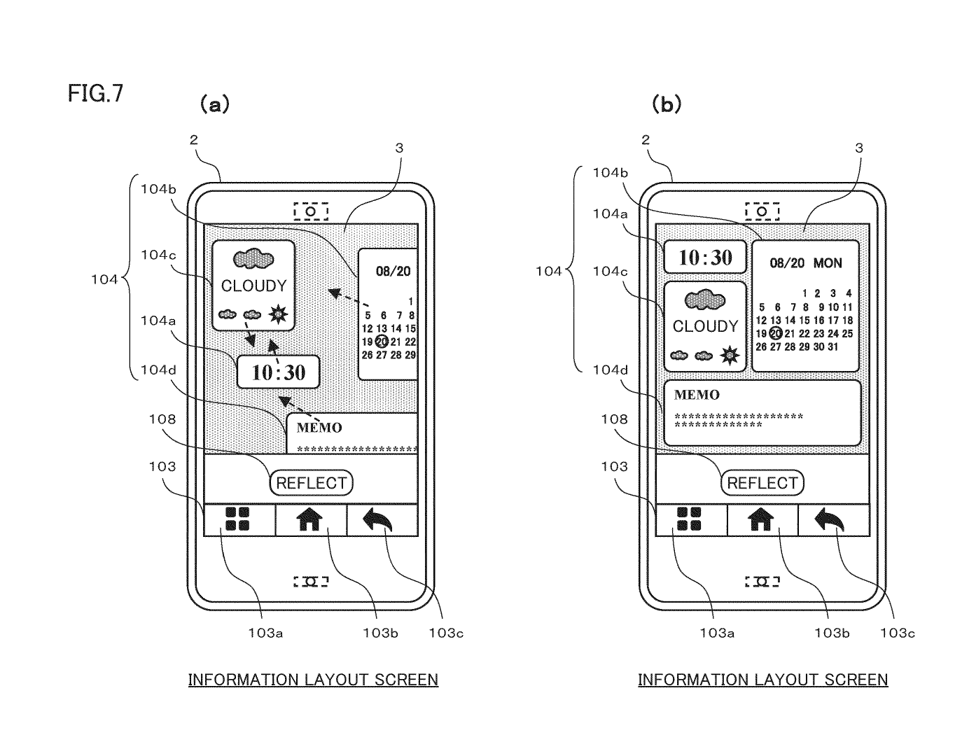

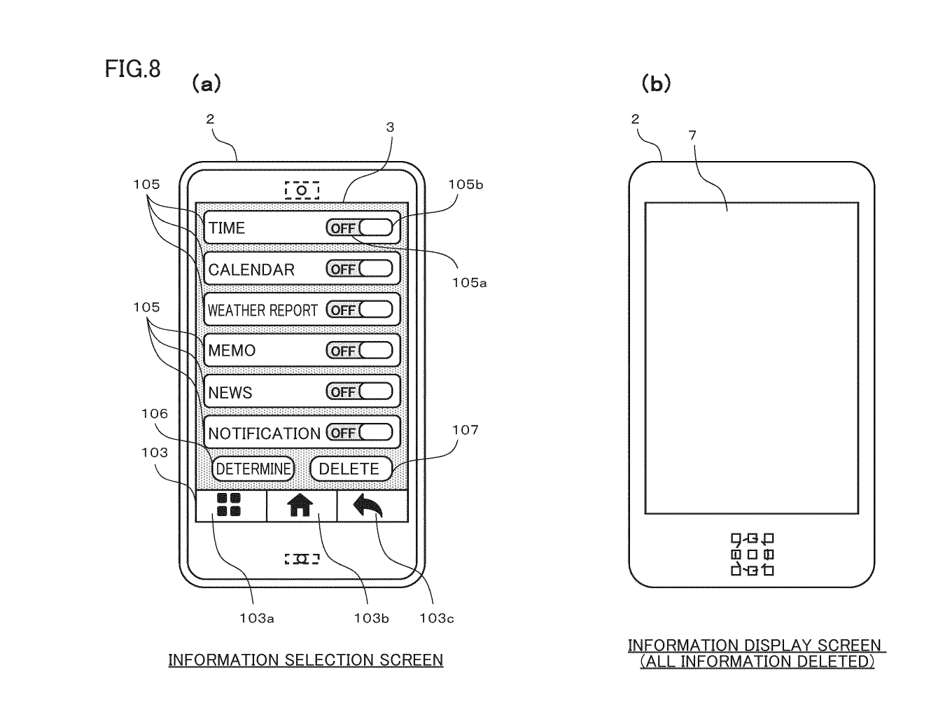

FIG. 5 is a flowchart showing a process associated with the information setting application. FIG. 6 shows an example of the information selection screen. FIG. 7 shows an example of an information layout screen. The information selection screen and the information layout screen are setting screens for setting pieces of information to be displayed on second display 7. FIG. 8 shows display states of first display 3 and second display 7 when a delete button 107 is operated.

With reference to FIG. 5 to FIG. 8, the following describes the process associated with the information setting application.

Control module 11 displays the information selection screen on first display 3 (S201). The information selection screen is a screen for selecting, from a plurality of candidates, information to be displayed on second display 7. As shown in FIG. 6, the information selection screen includes a selection object 105 corresponding to each candidate. FIG. 6 shows examples of the pieces of information serving as the candidates, such as “time”, “calendar”, “weather report”, “memo”, “news”, and “notification”. It should be noted that the information of “notification” include: information associated with updating of various types of applications; information on the number of newly received e-mails; information on the number of missed phone calls; and other information.

Each selection object 105 has a setting lever 105a. In the initial state, each information serving as a candidate is set as OFF and a tab module 105b is located at the right side region of setting lever 105a in each of the selection objects 105 as shown in FIG. 6 (a). On this occasion, setting lever 105a involves an indication of “OFF”.

Control module 11 determines whether or not an ON setting operation is performed onto the information set as OFF (S202). When turning ON the information set as OFF, the user performs a drag operation as the ON setting operation to move tab module 105b from the right side region to the left side region of setting lever 105a. When the ON setting operation is performed (S202: YES), control module 11 sets, as ON, the information for which the operation has been performed (S203). It should be noted that when tab module 105b is located at the left side, setting lever 105a involves indication of “ON”.

Furthermore, control module 11 determines whether or not an OFF setting operation has been performed onto information set as ON (S204). When turning OFF the information set as ON, the user performs a drag operation as the OFF setting operation to move tab module 105b from the left side region to the right side region of setting lever 105a. When the OFF setting operation is performed (S204: YES), control module 11 sets the operated information to be OFF (S205).

In the example shown in FIG. 6 (b), the pieces of information of “time”, “calendar”, “weather report”, and “memo” are set as ON, whereas the pieces of information of “news” and “notification” are set as OFF.

The information selection screen includes a determination button 106 and delete button 107. Control module 11 determines whether or not determination button 106 has been operated and whether or not delete button 107 has been operated (S206, S207).

When turning ON the information to be displayed on second display 7, the user performs a tap operation onto determination button 106. When determination button 106 is operated (S206: YES), control module 11 displays the information layout screen on first display 3 (S208). On this occasion, control module 11 reads each piece of information set as ON from a file in which each piece of information is stored in memory module 12, generates information image 104 indicating each piece of information, and places the generated information image 104 at an initial position on the information layout screen.

As shown in FIG. 6 (b), when the pieces of information of “time”, “calendar”, “weather report”, and “memo” are set as ON, time image 104a, calendar image 104b, weather image 104c, and memo image 104d are placed at initial positions on the information layout screen as shown in FIG. 7 (a).

On the information layout screen, the user can place each of information images 104 at a desired position. In this case, the user performs a drag operation onto an information image 104 as a moving operation to move information image 104 to a desired position (see broken line arrows in FIG. 7 (a)). When a moving operation is performed to an information image 104 on the information layout screen (S209: YES), control module 11 moves information image 104 in accordance with the moving operation (S210). FIG. 7 (b) shows that time image 104a, calendar image 104b, weather image 104c, and memo image 104d are placed by the user at desired positions on the information layout screen.

The information layout screen includes a reflection button 108. Control module 11 determines whether or not reflection button 108 has been operated (S211). When the user completes placing each information image 104 on the information layout screen, the user performs a tap operation onto reflection button 108.

When reflection button 108 is operated (S211: YES), control module 11 displays, on second display 7, the information display screen having information images 104 placed in the same manner as the arrangement thereof on the information layout screen as shown in FIG. 3 (b) (S212). On this occasion, control module 11 appropriately converts the resolution or color of each information image 104 into resolution and color suitable for second display 7. The size of each information image 104 in second display 7 is the same as that of each information image 104 having been displayed on first display 3.

Furthermore, control module 11 closes the information layout screen of first display 3 (S213), and ends the information setting application. On first display 3, the home screen is displayed again.

When the user wishes to change the pieces of information on second display 7, the user launches the information setting application and changes the ON/OFF setting of each piece of information on the information selection screen. On the other hand, when the user wishes to delete all the pieces of information displayed on second display 7, the user performs a tap operation onto delete button 107 on the information selection screen. When delete button 107 is operated (S207: YES), control module 11 sets all the pieces of information as OFF (S214) and deletes all the information images 104 on second display 7 (S215).

As shown in FIG. 8 (a), in all the selection objects 105, setting levers 105a come into the OFF state. Furthermore, as shown in FIG. 8 (b), second display 7 does not display anything.

It should be noted that as shown in FIG. 7 and FIG. 8, operation key group 103 is disposed at the lower portion of the information selection screen and the lower portion of the information layout screen. In the information selection screen, when the user performs a tap operation onto back key 103c, control module 11 undoes the indication on first display 3 to the immediately previous state and displays the home screen on first display 3. Moreover, in the information layout screen, when the user performs a tap operation onto back key 103c, control module 11 undoes the indication on first display 3 to the immediately previous state and displays the information selection screen on first display 3.

As described above, according to the present embodiment, small pieces of information, which the user wishes to check frequently, such as time information and weather information can be displayed on second display 7. Hence, even when mobile phone 1 is not operated and first display 3 is accordingly turned off, the user can readily check such small pieces of information. Moreover, second display 7 does not require electric power to keep displaying an image, so that even when these pieces of information are kept on being displayed on second display 7, it is possible to maintain the effect of suppressing power consumption by turning off first display 3.

Therefore, when the user places mobile phone 1 as being turned over, i.e., as the first display facing down on a desk or the like, the user can readily check necessary information using second display 7 while suppressing power consumption of mobile phone 1.

Furthermore, according to the present embodiment, the user uses first display 3 to perform settings of pieces of information (information images 104) to be displayed on second display 7 and perform an operation for layout, thereby displaying each piece of information arranged in the layout on second display 7. Therefore, a touch panel that can detect an operation to second display 7 does not need to be provided in the rear surface of cabinet 2. Moreover, since the settings of the pieces of information and the operation for layout can be performed in first display 3 that is fast in rate of renewing images, such operations can be performed smoothly.

Furthermore, according to the above-described embodiment, second display 7 has substantially the same size as first display 3, so that a piece of information (information image 104) can be displayed largely in size on second display 7, thus facilitating the user to check the information.

Heretofore, the embodiment of the present disclosure has been described, but the present disclosure is not restricted in any sense by the embodiment and the like and the embodiment of the present disclosure can be modified in various manners in addition to the configuration described above.

<Modification 1>

In a modification 1, when a predetermined application is executed, the user can set, on the execution screen of the application, information to be displayed on second display 7.

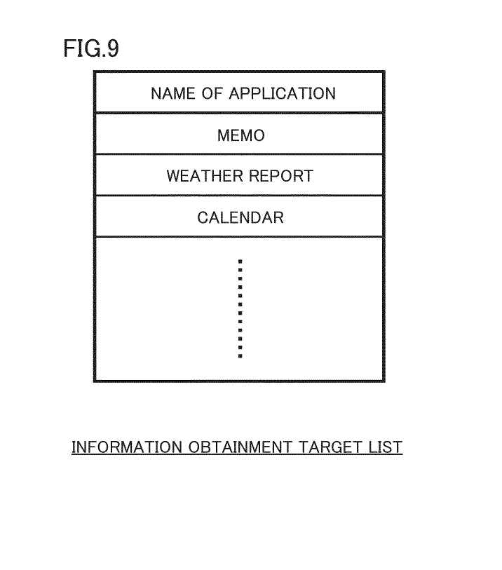

In the present modification, an information obtainment target list shown in FIG. 9 is stored in memory module 12. In the information obtainment target list, applications for which pieces of information to be displayed on second display 7 are obtained are registered in advance, such as the memo pad application, the weather report application, and the calendar application.

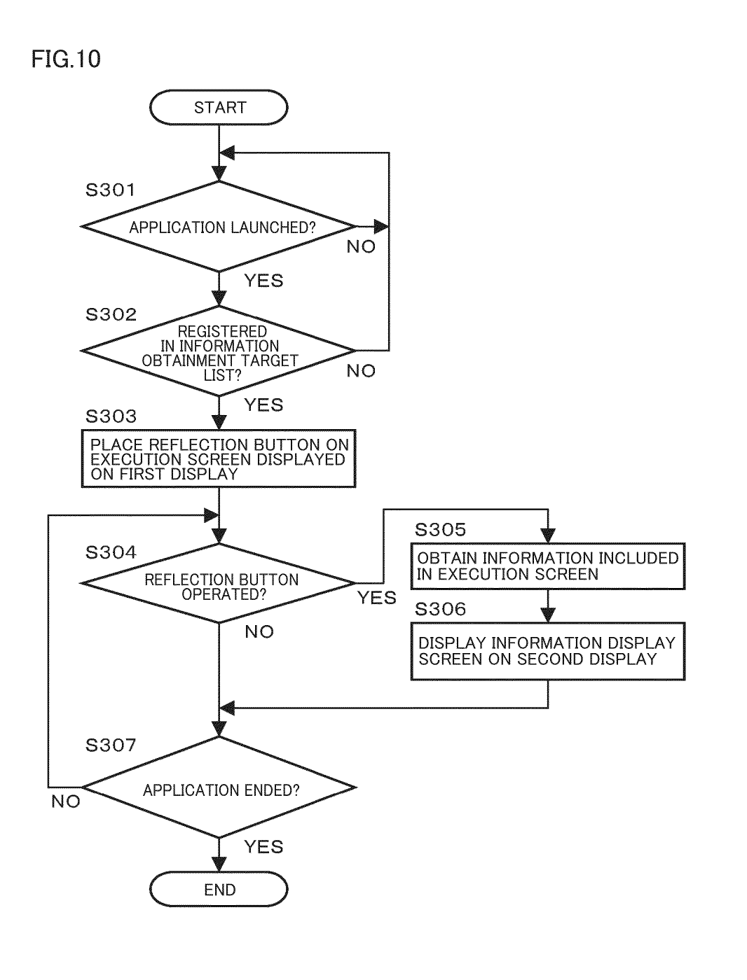

FIG. 10 is a flowchart showing a setting process for setting information to be displayed on second display 7 according to the present modification.

When an application is launched (S301: YES), control module 11 determines whether or not the launched application has been registered in the information obtainment target list (S302). When the launched application is in the information obtainment target list (S302: YES), control module 11 displays a reflection button on the execution screen displayed on first display 3 (S303). When the reflection button is operated (S304: YES), control module 11 obtains information included in the execution screen (S305) and displays an information image 104 indicating the obtained information on second display 7 (S306). When the application is ended (S307: YES), control module 11 ends the setting process.

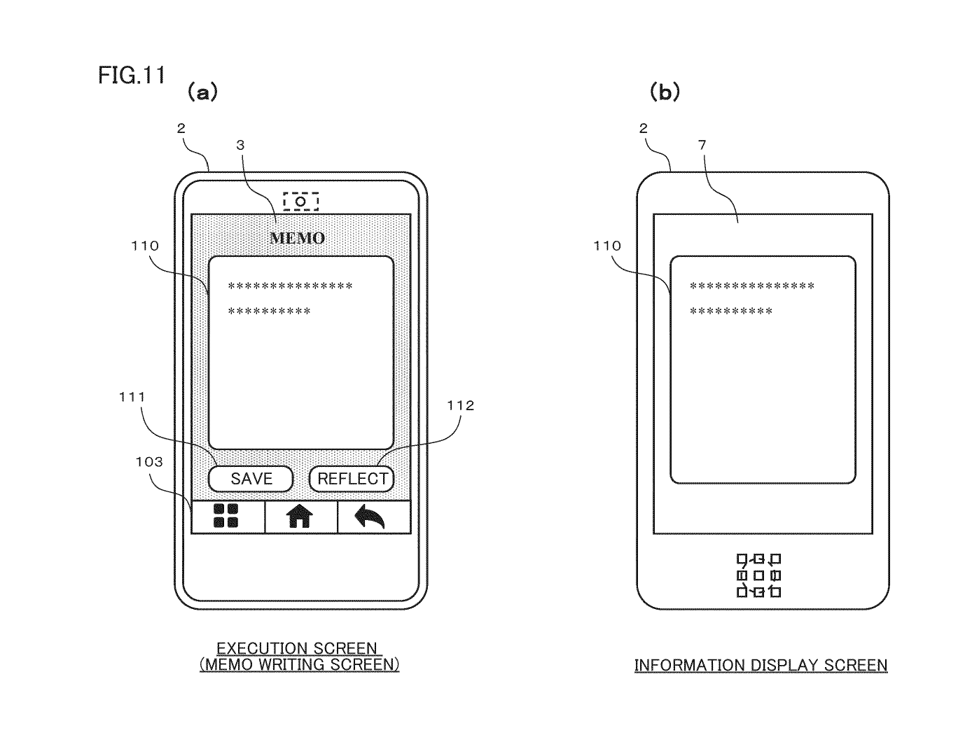

FIG. 11 shows an example in which information to be displayed on second display 7 is set on a memo writing screen in the memo pad application.

As shown in FIG. 11 (a), in the memo writing screen, a reflection button 112 is disposed in addition to a memo writing region 110 and a save button 111. In order to reflect, in second display 7, the memo writing created in memo writing region 110, the user performs a tap operation onto reflection button 112. Accordingly, as shown in FIG. 11 (b), an information display screen including memo writing region 110 having the memo writing thereon is displayed on second display 7. It should be noted that when the user performs a tap operation onto save button 111, the memo writing in memo writing region 110 is stored in a predetermined file of memory module 12.

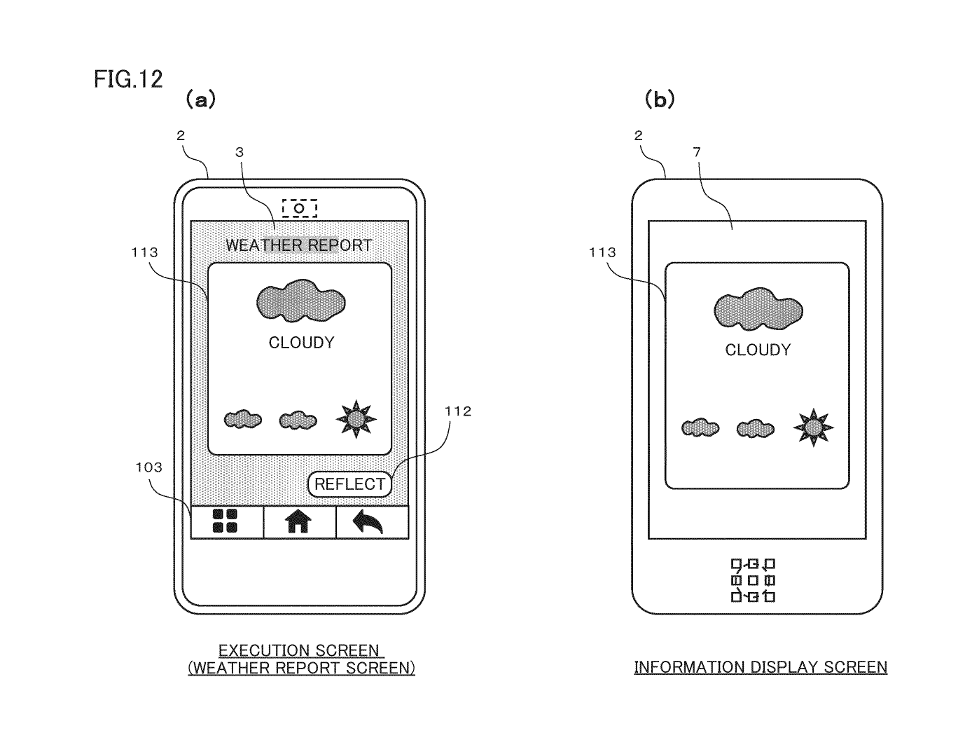

FIG. 12 shows an example in which information to be displayed on second display 7 is set on the weather report screen in the weather report application.

As shown in FIG. 12 (a), reflection button 112 is disposed in the weather report screen in addition to weather report image 113. In order to reflect the weather report in second display 7, the user performs a tap operation onto reflection button 112. In this way, as shown in FIG. 12 (b), an information display screen including weather report image 113 is displayed on second display 7.

It should be noted that in the present modification, the user may be able to use a predetermined setting screen to register a desired application into the information obtainment target list.

As described above, according to the present modification, the user can readily set a piece of information to be displayed on second display 7, using an execution screen of an application.

<Modification 2>

In a modification 2, when the amount of charges remaining in the battery becomes small, information that may be required when mobile phone 1 cannot be used is displayed on second display 7. The amount of charges remaining in the battery may become small due to a situation that does not allow battery 21a to be charged such as occurrence of disaster or the like. Hence, emergency information such as information associated with the owner of mobile phone 1 (such as his/her name and blood type), the telephone number of mobile phone 1, a telephone number for emergency contact, and the like are stored in an emergency file of memory module 12 such that the emergency information is available to the user in the event of disaster or the like. These pieces of emergency information are set in advance by the user using a predetermined setting screen and are registered in the emergency file, for example.

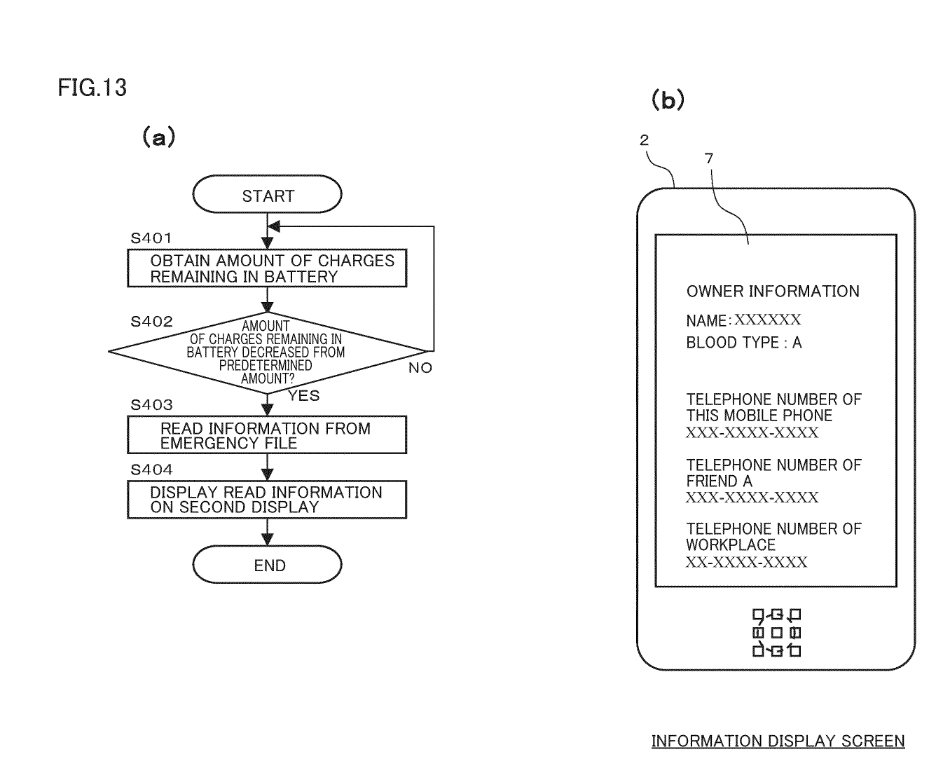

FIG. 13 (a) is a flowchart showing a display process with respect to second display 7 according to the present modification. FIG. 13 (b) shows an information display screen displayed on second display 7 when the amount of charges remaining in the battery becomes small.

Control module 11 obtains the amount of charges remaining in the battery from remaining charge amount detection module 21b (S401), and determines whether or not the obtained amount of charges remaining in the battery is decreased from a predetermined amount (for example, 1%) (S402).

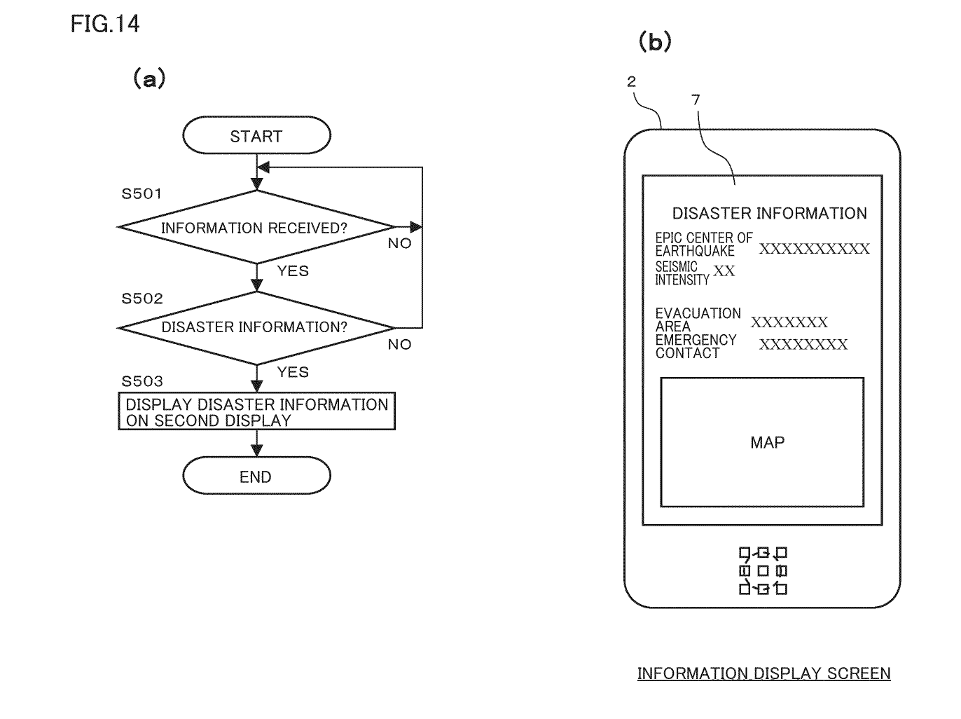

When the amount of charges remaining in the battery is decreased from the predetermined amount (S402: YES), control module 11 reads the information from the emergency file (S403) and displays, on second display 7, the read information, i.e., an emergency information display screen including the read information instead of an information display screen having been displayed till then (for example, the information display screen of FIG. 3 (b)) (S404). As shown in FIG. 14 (b), the name of the owner of mobile phone 1, his/her blood type, the telephone number of mobile phone 1, and the telephone numbers of friend(s) and workplace, which are emergency contacts, are displayed on second display 7, for example.

In this way, even when the amount of charges remaining in the battery thereafter becomes zero and mobile phone 1 becomes nonoperational, the information display screen on second display 7 is maintained. Therefore, the user can check the emergency information displayed on second display 7 as required even under circumstances that mobile phone 1 cannot be used.

When battery 21a is charged by the user and electric power is supplied to control module 11 from power supply module 21, control module 11 displays the information display screen that had been displayed on second display 7 before the amount of charges remaining in the battery was decreased from the predetermined amount. When mobile phone 1 comes into a state in which it can be used, the emergency information display screen including the personal information such as the name of the owner is deleted, thereby protecting the personal information.

It should be noted that whether to perform the display process of the present modification can be desirably set by way of the user's operation.

Further, the information displayed on second display 7 when the amount of charges remaining in the battery is decreased from the predetermined amount may not be the emergency information described above. Information that is preferably maintained to be displayed even under the circumstances that mobile phone 1 cannot be used may be displayed on second display 7.

<Modification 3>

In a modification 3, disaster information externally received is displayed on second display 7.

FIG. 14 (a) is a flowchart showing a display process with respect to second display 7 according to the present modification. FIG. 14 (b) shows second display 7 on which an information display screen including disaster information is displayed.

By the user making a predetermined registration in advance to a predetermined report organization that notifies disaster information, disaster information is transmitted to mobile phone 1 from the report organization in the event of disaster.

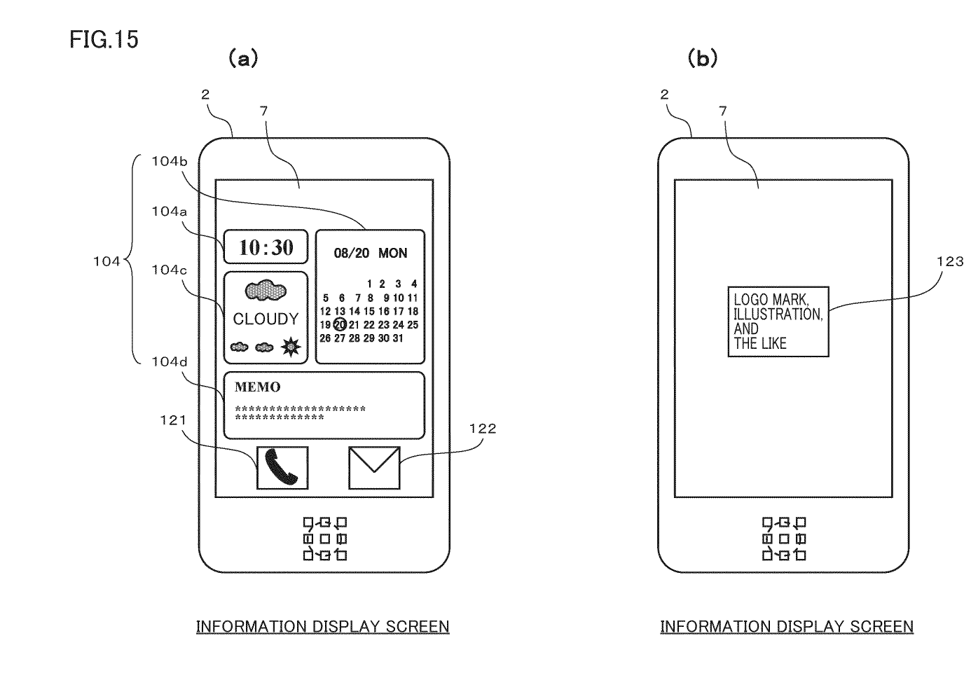

When information is received by communication module 20 from outside (S501: YES), control module 11 determines, based on the address of the sender or the like, whether or not the received information is disaster information (S502). When the received information is disaster information (S502: YES), control module 11 displays an information display screen including the disaster information on second display 7 instead of an information display screen having been displayed till then (for example, the information display screen of FIG. 3 (b)) (S503). As shown in FIG. 15 (b), for example, when the disaster is an earthquake, the epic center of the earthquake, the seismic intensity, an evacuation area, emergency contacts, and a map indicating the evacuation area and the emergency contacts are displayed on second display 7.

Thus, in the present modification, even when mobile phone 1 is not used and the lock function is set, the user can check the disaster information readily. Moreover, even when the amount of charges remaining in the battery is zero and mobile phone 1 cannot be used, the user can check the disaster information.

When the user launches the information setting application and makes settings for new information while the disaster information is displayed on second display 7, the newly set information is displayed on second display 7 instead of the disaster information.

It should be noted that whether to perform the display process of the present modification can be desirably set by way of the user's operation.

<Other Modification>

FIG. 15 shows an information display screen displayed on second display 7 according to the other modification.

As shown in FIG. 15 (a), an icon 121 indicating a missed phone call may be presented on the information display screen in the event of a missed phone call. Moreover, an icon 122 indicating reception of a new e-mail may be presented on the information display screen in the event of reception of an e-mail. Further, as shown in FIG. 15 (b), a non-functional image 123 such as a logo mark or an illustration may be displayed on second display 7 instead of the functional information such as time image 104a indicating the time information and calendar image 104b indicating the calendar information.

In the above-described embodiment, first display 3 and second display 7 are respectively provided in the front surface and rear surface of cabinet 2. However, second display 7 and first display 3 may be respectively provided in the front surface and rear surface of cabinet 2.

Moreover, in the above-described embodiment, second display 7 has substantially the same size as first display 3; however, second display 7 may be larger or smaller than first display 3.

Furthermore, in mobile phone 1 of the above-described embodiment, first display 3 and second display 7 are provided in one cabinet 2. However, the present disclosure is applicable to a mobile phone different in type from the above-described embodiment.

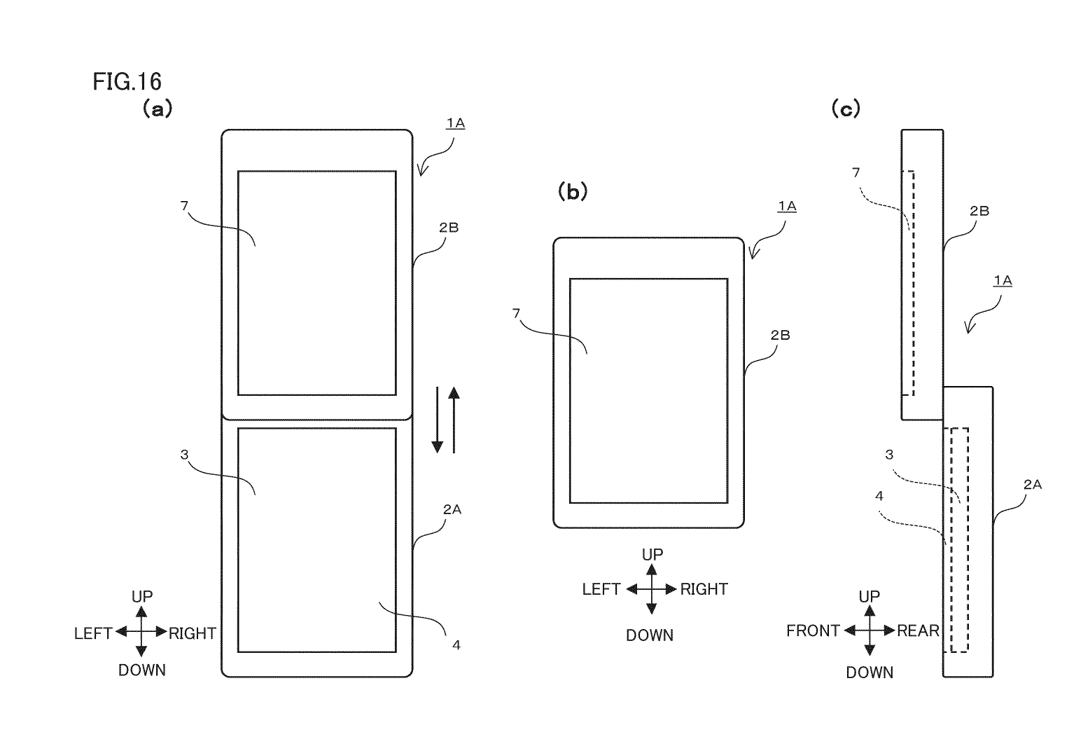

FIG. 16 shows an configuration of a mobile phone 1A according to the other modification. Mobile phone 1A includes: a first cabinet 2A; and a second cabinet 2B that can be slid upwardly and downwardly relative to first cabinet 2A. First cabinet 2A is provided with first display 3 and touch panel 4 and second cabinet 2B is provided with second display 7. As shown in FIG. 16 (b), when mobile phone 1A is closed, only first display 3 is exposed to outside. As shown in FIG. 16 (a) and FIG. 16 (c), when mobile phone 1A is opened, both first display 3 and second display 7 are exposed to outside.

Furthermore, in the above-described embodiment, in the process associated with the information setting application, the information layout screen is displayed such that each information image 104 can be arranged freely. However, the information layout screen does not necessarily need to be displayed. In this case, in the information selection screen, a reflection button 108 is provided instead of determination button 106. When reflection button 108 is operated, the information display screen having each information image 104 arranged at a predetermined position is displayed on second display 7.

Furthermore, in the above-described embodiment, second display 7 does not require electric power to keep displaying an image, but may at least require less electric power than first display 3 to keep displaying an image. For example, first display 3 and second display 7 may differ from each other in display type such that first display 3 is a general liquid crystal display and second display 7 is an electronic paper display, and second display 7 requires less electric power than first display 3 to keep displaying an image. Moreover, in this case, it can be said that second display 7 at least requires less electric power per unit area than first display 3 to keep displaying an image.

The configurations of the present embodiment and modifications 1 to 3 can be combined with one another appropriately.

The present disclosure is not limited to the mobile phone and is applicable to various types of mobile terminal devices such as a PDA (Personal Digital Assistant), a tablet PC, and an electronic book terminal.

In addition, the embodiments of the present disclosure can be appropriately modified in various manners within the scope of the technical concept presented in the appended claims.

Although the present disclosure has been described and illustrated in detail, it is clearly understood that the same is by way of illustration and example only and is not to be taken by way of limitation, the scope of the present disclosure being interpreted by the terms of the appended claims.

1. A mobile terminal device comprising:
a housing comprising a first surface and a second surface different from the first surface;
a first display module provided in the first surface, the first display module requiring electric power to keep displaying an image;
an operation detection module configured to detect an operation performed by a user onto the first display module;
a second display module provided in the second surface, the second display module requiring less electric power than the first display module to keep displaying an image; and
a control module configured to control the first display module and the second display module,
the control module being configured to
display an image on the first display module in accordance with the operation and turn off the first display module when the operation has not been detected by the operation detection module for a predetermined time, and
display predetermined information on the second display module, the predetermined information being able to be seen by the user when the first display module is off.

2. The mobile terminal device according to claim 1, wherein the predetermined information includes at least one of time information, calendar information, weather information, and memo information.

3. The mobile terminal device according to claim 1, wherein
the control module is configured to
display, on the first display module, a screen in which a setting operation is performed by the user to set the predetermined information, and
display the set predetermined information on the second display module in response to the setting operation being detected by the operation detection module.

4. The mobile terminal device according to claim 3, wherein the control module is configured to display an information selection screen on the first display module as the screen in which the setting operation is performed, the information selection screen being configured for selection of the predetermined information from a plurality of candidates.

5. The mobile terminal device according to claim 3, wherein the control module is configured to display an execution screen of an application on the first display module as the screen in which the setting operation is performed, the execution screen being provided with a setting button, and the control module is configured to display information, which is indicated in the execution screen, on the second display module as the predetermined information when an operation onto the setting button is detected by the operation detection module.

6. The mobile terminal device according to claim 1, further comprising a remaining charge amount detection module configured to detect an amount of charges remaining in a battery, wherein
when the amount of charges remaining in the battery is decreased from a predetermined amount, the control module is configured to display, on the second display module as the predetermined information, information determined in advance as information that is to be maintained to be displayed even when there are no charges remaining in the battery.

7. The mobile terminal device according to claim 1, further comprising a reception module configured to receive information, wherein
when the reception module receives disaster information, the control module is configured to display the disaster information on the second display module as the predetermined information.

8. The mobile terminal device according to claim 1, wherein the second surface is opposite to the first surface.
